(19) United States
(12) Patent Application Publication
(10) Pub. No.: US 2020/0116291 A1
(43) Pub. Date: Apr. 16, 2020

(54) REHABILITATION OF HIGH-TEMPERATURE PIPES

(71) Applicant: SAERTEX multiCom GmbH, Saerbeck (DE)

(72) Inventors: Frank Mersmann, Saerbeck (DE); Nils Fuechtjohann, Greven (DE)

(21) Appl. No.: 16/577,980

(22) Filed: Sep. 20, 2019

(30) Foreign Application Priority Data
Sep. 21, 2018 (DE) 10 2018 123 339.6

(51) Int. Cl. F16L 55/165

(52) U.S. Cl. CPC F16L 55/1656

(57) ABSTRACT

The present disclosure relates to a high-temperature liner for rehabilitating multilayered high-temperature pipes, a rehabilitated high-temperature pipe, the use of the high-temperature liner and a process for rehabilitating high-temperature pipes.

### CROSS-REFERENCE TO RELATED APPLICATION

This is a U.S. patent application which claims priority to German Patent Application No. 102018123339.6 filed on Sep. 21, 2018, contents of which is incorporated herein by reference in their entireties.

### BACKGROUND

The present disclosure relates to a multilayered high-temperature liner for rehabilitating district heating pipes, for example, a rehabilitated high-temperature pipe such as a district heating pipe, the use of said high-temperature liner and a process for rehabilitating high-temperature pipes such as district heating pipes.

### SUMMARY

Up to the present, it has not been possible to rehabilitate high-temperature pipes using conventional liner technology. District heating pipes to be rehabilitated usually had to be excavated and replaced.

Often water or water vapour is used as a medium to transfer heat through district heating pipes.

US 2009 0107558 A1 describes that a pipe surrounding the district heating pipe as such can be a bit larger to allow the district heating pipe to be pulled out and replaced.

EP 3 062 010 A1 and JP 5538230 B2 each describe a liner that supposedly can also be used to rehabilitate district heating pipes. However, they do not propose a solution that enables a suitable configuration of the respective curable liner described there for the aggressive conditions found in district heating pipes. Namely, under these conditions properties such as hydrolysis resistance and heat resistance are important which are not discussed in these documents.

DE 19608352 C1 proposes a liner for the rehabilitation of district heating pipes wherein a metallic pipe is inserted into the cured liner.

WO 2009/153193 A1 describes a diol for powder paints. In the subsequent patent literature this document has been cited exclusively in the field of detergents and cleaning agents.

WO 2017/061944 A1 describes a liner for the rehabilitation of district heating pipes wherein a coating of the resin-impregnated fibrous layer is not provided for.

It is an object of the present invention to provide a technology that allows high-temperature pipes such as district heating pipes, for instance, to be rehabilitated in a straightforward and reliable manner without trenches.

### DETAILED DESCRIPTION OF EMBODIMENTS

In a first embodiment, an advantageous feature of the invention is provided by a multilayered high-temperature liner, wherein a fibrous layer contain

s fibres that have been impregnated with a resin composition, wherein an internal coating or a moisture-repellent tube that forms the final layer within the rehabilitated high-temperature pipe in the direction of the central axis of the high-temperature pipe has a thickness in a range of from 40 to 2000 μm, preferably from 50 to 1000 μm.

Preferably, the resin composition contains an unsaturated polyester (alternatively also a vinyl ester) that is formed from the polycondensation of unsaturated carboxylic acid derivatives with diols and

a) at least one diamine and/or

b) at least one dialkyl or diaryldiol of the general formula I

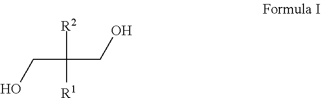

wherein R¹ and R² are alkyl- or aryl- and are the same or different.

Due to this very specific selection of materials for the resin and the interior coating or the moisture-repellent tube (materials will be specifically defined hereinafter) of the high-temperature liner, this liner with its increased heat resistance and its increased hydrolysis resistance is more suitable for the rehabilitation of high-temperature pipes such as district heating pipes, for instance, than the previously known liners.

The term high-temperature liner as used according to the present invention preferably relates to a liner that is suitable for a continuous temperature load in range from 40 to 250° C., exceptionally preferably from 50 to 160° C. The high-temperature liner is preferably suitable for a continuous compressive load in a range from 2.5 to 40 bar, particularly preferably from 10 to 25 bar.

### General Design of the High-Temperature Liner

In this application, the order of the layers of the liner according to an embodiment of the invention is based on the order that would exist in the rehabilitated pipe or the pipe to be rehabilitated such as a district heating pipe, for example. The high-temperature liner according to an embodiment of the invention comprises an internal coating or a moisture-repellent tube. The internal coating or the moisture-repellent tube is the final layer towards the centre of the pipe. Optionally, an exterior layer can be provided that is arranged at the interface towards the inner wall of the pipe to be rehabilitated. Various other layers such as the at least one resin-impregnated fibrous layer, for example, can be arranged between the internal coating or the moisture-repellent tube and the inner wall of the pipe to be rehabilitated. It is known that these layers can exist in the reverse order in the ready-for-sale product before installation since pipes such as district heating pipes, for instance, can also be rehabilitated using an inversion method. However, they can also exist in the ready-for-sale product in exactly this order if the pipes and particularly district heating pipes are rehabilitated using an insertion process.

Various variants for a concrete embodiment of the high-temperature liner exist. Some variants will be discussed hereinbelow without any claim to completeness. They are preferred embodiments:

### Variant A

The internal coating can have a styrene barrier layer, for example. Then, the internal coating can preferably be anchored to the at least one fibrous layer using an anchor layer. In this variant, both the internal coating and the styrene barrier layer (and optionally an anchor layer) would remain in the rehabilitated high-pressure pipe in the cured state.

### Variant B

The internal coating may not have a styrene barrier layer, for example. Then, the internal coating can preferably be anchored to the at least one fibrous layer using an anchor layer. In order to cure the high-temperature liner, a tubular film with a styrene barrier layer serving as an installation aid would then be arranged in the high-temperature liner to be cured before curing. After curing, this installation aid would be removed. Alternatively, a moisture-repellent tube comprising a styrene barrier layer that remains in the liner after curing can be used. The high-temperature liner in the rehabilitated high-temperature pipe can, but does not have to contain an inner styrene barrier layer.

### Variant C

The high-temperature liner according to an embodiment of the invention can also be obtained by curing a resin-impregnated fibrous layer using a tubular film with a styrene barrier layer as an installation aid, removing said layer after curing and subsequently inserting a moisture-repellent tube to obtain the high-temperature liner according to an embodiment of the invention. Alternatively, a moisture-repellent tube comprising a styrene barrier layer that remains in the liner after curing can be used directly.

### Variant D

The high-temperature liner according to an embodiment of the invention can also be obtained by inserting a moisture-repellent tube comprising a styrene barrier layer before curing the resin-impregnated fibrous layer, where the tube remains in the rehabilitated high-temperature pipe after curing to obtain the high-temperature liner according to an embodiment of the invention.

The internal coating or the moisture-repellent tube preferably contains at least 20% by weight of a material selected from the group of polyamide, EVOH, polypropylene, polymethylpentene, polyethylene, crosslinked polyethylene, poly(organo)siloxanes, fluoropolymers, fluoroelastomers, nitrile rubbers, aliphatic polyketones, polyetherketones, polyphenylene sulfides and/or any mixtures thereof. Mixtures thereof can be obtained by blends, but also by various layers of the materials. For example, the internal coating or the moisture-repellent tube can also contain at least more than 60% by weight of mixtures of these materials.

Preferably, an anchor layer can be arranged between the at least one resin-impregnated fibrous layer and the internal coating. Preferably, the anchor layer can be integrally bonded (laminated, for instance) to the internal coating. Preferably, the anchor layer is bonded in a non-positive and/or positive fit to at least one fibrous layer after curing of the liner. The anchor layer can be a nonwoven fabric, particularly preferably a polymer nonwoven fabric. A nonwoven fabric within the meaning of an embodiment of the invention also comprises felt.

Alternatively, a moisture-repellent tube that is not connected to the at least one resin-impregnated fibrous layer can be used. The moisture-repellent tube can also be a tube or a tubular film that remains in the rehabilitated pipe.

Alternatively, the moisture-repellent tube can also be inserted into the pipe to be rehabilitated in the form of a tube or a tubular film after curing of the liner. This can be advantageous in that a tube such as a silicone tube, for example, can be inserted subsequently to protect the cured previously resin-impregnated fibrous layer from water vapour, for example, and thus from hydrolysis. In this case, the moisture-repellent tube is preferably not bonded in a non-positive and/or positive fit to at least one of the other layers. Then, the moisture-repellent tube can simply be pressed to one of the other layers such as a fibrous layer, for example, by the internal pressure of a district heating medium.

Preferably, the fibrous layer of the high-temperature liner according to an embodiment of the invention is not coiled or loosely folded. This has the advantage that the liner remains more stable when inserted into the pipe to be rehabilitated, for instance.

The installation aid is preferably a tubular film with a styrene barrier layer. This layer can have the preferred properties described further below. The installation aid can be a tubular film made of a composite film, for example. This composite film can comprise at least three polyolefin/polyamide/polyolefin layers, for example. The thickness of the installation aid can be in a range from 30 to 200 μm, for instance. The installation aid is preferably removed from the high-temperature liner after curing of the resin composition. In addition, an adhesion promotor can also be disposed between the composite film layers.

The moisture-repellent tube can have a wall thickness in a range from 50 to 3000 μm. The moisture-repellent tube can preferably contain a polyamide, EVOH, polypropylene, polymethylpentene, polyethylene, crosslinked polyethylene, poly(organo)siloxane, fluoropolymer, fluoroelastomer, nitrile rubber, aliphatic polyketone, polyetherketone, polyphenylene sulfide and/or mixtures thereof. Preferably, the moisture-repellent tube contains 20 to 100% by weight of these materials or mixtures thereof.

### Resin Composition

The resin composition can be polyester-, polyurethane-, epoxide- and/or vinylester-based.

The resin composition preferably contains a reactive diluent and an unsaturated polyester obtainable from a polyester starting mixture. Preferably, the resin composition contains from 30 to 60% by weight, exceptionally preferably from 40 to 50% by weight of a reactive diluent and from 40 to 70% by weight, exceptionally preferably from 50 to 60% by weight of an unsaturated polyester. Preferably, the resin composition contains a reactive diluent and an unsaturated polyester in a mass ratio between the reactive diluent and the unsaturated polyester of from 1:1.5 to 1:1.

The reactive diluent can preferably be selected from the group of styrene, para-methyl styrene, alpha-methyl styrene, tert-butyl acrylate, vinyltoluene, tert-butylstyrene, 4-vinylpyridine, 3-vinylpyridine, 2-vinylpyridine, methyl methacrylate, divinylbenzene, 1,2,4-trivinylcyclohexane, diallyl phthalate, diallyl isophthalate, triallyl isocyanurate and/or mixtures thereof. Styrene is a particularly preferred reactive diluent.

Preferably, the resin composition contains from 0.1 to 3% by weight of a photoinitiator. Said photoinitiator can preferably also be a photoinitiator mixture.

Preferably, the resin composition contains from 1 to 10% by weight of a thickener. The thickener can be organic or inorganic. The thickener can preferably be selected from alkaline earth metal oxides, alkaline earth metal hydroxides, aliphatic polyisocyanates and/or mixtures thereof.

The resin composition can also contain from 0.4 to 2.5% by weight, very particularly preferably from 0.5 to 1.5% by weight of a peroxide initiator, for example. The peroxide initiator can be 1,1-bis(tert-butylperoxy)-3,3,5-trimethylcyclohexane, for instance.

For example, the resin composition can be obtained by diluting the unsaturated polyester with a reactive diluent and adding a photoinitiator, a thickener and a peroxide initiator. Preferably, the resin composition can be obtained by diluting the unsaturated polyester with a reactive diluent and adding a photoinitiator and a thickener.

Preferably, from 1.4 to 4, particularly preferably from 2 to 2.5 molecules of the reactive diluent per double bond of the unsaturated polyester resin exist in the resin composition.

Preferably, the resin composition has a density in a range from 1.01 g/cm³ to 1.26 g/cm³ without fillers.

The resin composition can preferably also contain from 5 to 40% by weight, very particularly preferably from 20 to 30% by weight of inorganic fillers. These fillers can be metal oxides such as alumina, for example. The fillers can be powders or a granulate, for example.

### Unsaturated Polyester

In addition to other components, the resin composition preferably contains a polyester (particularly preferably an unsaturated polyester) that has been obtained from a polyester starting mixture, that is, a mixture that can cure to form a polyester or derivatives (such as a polyester amide, for example).

Preferably, the unsaturated polyester is obtainable from a polyester starting mixture by a polycondensation reaction. Preferably, the unsaturated polyester is an unsaturated polyester amide.

For example, the unsaturated polyester, which is often solid or semisolid at room temperature, is prepared by a polycondensation in the melt of dicarboxylic acids and anhydrides that are at least partially functionalised with a radically reactive double bond and diols. For example, after mixing the unsaturated polyester and the reactive diluent, a resin referred to as an unsaturated polyester resin (UP resin) is obtained which is usually liquid at room temperature. The free-radical curing (chemical crosslinking) of the UP resin results in a so-called UP thermoset plastic or UP network. After the polycondensation of the dicarboxylic acid and/or the anhydride on the one hand and the diol on the other hand, the unsaturated polyester is obtained as a mixture of a polymer, an oligomer and residual monomer according to the respective molecular weight distribution, for example.

All following weight percentages in this section always refer to 100% by weight of the polyester starting mixture.

This polyester starting mixture preferably contains from 40 to 60% by weight, very particularly preferably from 45 to 55% by weight of unsaturated carboxylic acid equivalents. The carboxylic acid equivalents can be selected from carboxylic acids with 2 or 3 acid groups, the anhydrides and/or any mixtures thereof. The carboxylic acid equivalents can preferably be selected from fumaric acid, trimellitic anhydride (TMA), phthalic anhydride, maleic anhydride, isophthalic acid and/or any mixtures thereof.

Preferably, the molar ratio of the anhydride to the carboxylic acid ranges from 1.1:1 to 1.6:1.

This polyester starting mixture preferably contains from 40 to 60% by weight, very particularly preferably from 45 to 55% by weight of diamines and/or diols.

The diamines can preferably be cycloalkanediamines. The cycloalkanediamine isophoronediamine is very particularly preferred. The polyester starting mixture can preferably contain an amount in a range of 10 to 20% by weight of the diamines.

The diols can preferably be cycloalkane diols. The polyester starting mixture can preferably contain an amount in a range of 20 to 35% by weight of these cycloalkane-based diols. The cycloalkane-based diols can preferably be selected from the group of cyclohexanedimethanol, isosorbide and/or mixtures thereof.

The diols can preferably also be dialkyl or diaryldiols of the general formula I:

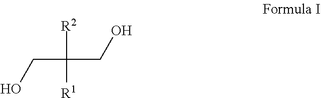

wherein R¹ and R² are alkyl or aryl moieties and can be the same or different. The polyester starting mixture can preferably contain an amount in a range of 10 to 30% by weight of these diols.

The moiety R¹ and/or R² is preferably selected from methyl-, ethyl-, n-propyl-, propyl, n-butyl-, i-butyl-, n-pentyl-, 2-methylbutyl-, 3-metylbutyl-, phenyl- and/or combinations thereof. Very particularly preferably, R¹ is methyl-.

Preferably, the diols can contain from 10-30% by weight of neopentyl glycol, based on the polyester starting mixture.

Preferably, the diols can contain from 10-30% by weight of the dialkyl or diaryldiols defined above.

Preferably, the polyester starting mixture contains from 10 to 20% by weight of dialkyl or diaryldiols of the general formula I, from 20 to 35% by weight of cycloalkane diols and from 10 to 20% by weight of cycloalkanediamines.

Preferably, the weight ratio between diols and diamines in the polyester starting mixture can be in a range from 3:1 to 25:1.

Preferably, the molar ratio between diols and diamines in the polyester starting mixture can be in a range from 4:1 to 20:1.

Preferably, the polyester starting mixture contains a molar ratio of carboxylic acid equivalents on the one hand to diols and/or diamines on the other hand in a range from 1.5:1 to 4:1. The diols can also comprise the following diols: ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,5-hexadiene-3,4-diol, 1,2- and 1,3-cyclopentanediol, 1,2-, 1,3- and 1,4-cyclohexanediol, 1,1-, 1,2-, 1,3- and 1,4-bis(hydroxymethyl)cyclohexane, 1,1-, 1,2-, 1,3- and 1,4-bis(hydroxyethyl)cyclohexane, neopentyl glycol, (2)-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, diethylene glycol, triethylene glycol, dipropylene glycol, tripropylene glycol, polyethylene-polypropylene glycol, wherein the sequence of the ethylene oxide or propylene oxide units can be blockwise or random, or mixtures of two or more members of the above-mentioned compounds. One or even both hydroxyl groups in the above-mentioned diols can be substituted by SH groups.

The molar ratio of the carboxylic acid equivalent on the one hand and the diol on the other hand is preferably in a range from 0.9:1 to 1:0.9, particularly preferably from 1.03:1 to 0.97:1 to produce unsaturated polyesters having optimal molecular weights. Moreover, occurring side reactions that result in the formation of volatile by-products can strongly influence the required stoichiometry. If butanediol-1,4 is used, tetrahydrofuran is formed; if 1,2-propylene glycol is used, 2-ethyl-4-methyl-1,3-dioxolane is formed, for example. Both side reactions can require the use of a significant excess in the condensation. In the case of 1,2-propylene glycol said excess is preferably 7-15 mole %, in the case of 1,4-butanediol preferably about 30 mole %.

Preferably, the polyester starting mixture contains from 0.01 to 0.1% by weight of an inhibitor. Preferably, the inhibitor is selected from the group of hydroquinone, toluene hydroquinone, 4-tert-butylhydroquinone, 4-tert-butylpyrocatechol, naphthoquinone, 1,2-dihydroxynaphthalene, 1,4-dihydroxynaphthalene and/or mixtures thereof.

Preferably, the polyester starting mixture contains from 0.01 to 0.1% by weight of a catalyst. The catalyst is preferably a catalyst for esterification. The catalyst can be hydrogenated butyl stannoic acid, for instance.

The polyester starting mixture preferably contains (i) an unsaturated dicarboxylic acid, an ester or an anhydride thereof, (ii) an aliphatic diol, (iii) dianhydrohexitol, (iv) a cycloaliphatic diol or an aromatic diol and (v) an amide-forming agent.

Here, (i) (namely an unsaturated dicarboxylic acid, an ester or an anhydride thereof) preferably comprises maleic acid, fumaric acid, itaconic acid, mesaconic acid, citraconic acid, citric acids and/or maleic anhydride, esters or anhydrides of the above-mentioned carboxylic acids or any mixtures thereof.

Preferably, (ii) (that is, an aliphatic diol) comprises 1,4-butanediol, 2-(2-hydroxyethoxy)ethane-1-ol, 3-(3-hydroxypropoxy)propane-1-ol, 2,2-dimethylpropane-1,3-diol, 2-ethyl-2-methylpropane-1,3-diol, 2-butyl-2-ethylpropane-1,3-diol, 3-hydroxy-2,2-dimethylpropyl-3-hydroxy-2,2-dimethyl propionate, ethane-1,2-diol, propane-1,2-diol, 4-oxa-2,6-heptanediol, 2-(2-hydroxypropoxy)propane-1-ol, 2-(2-hydroxy-1-methylethoxy)propane-1-ol (dipropyleneglycol or DPG) or any mixtures thereof.

Preferably, (iii) (that is, dianhydrohexitol) comprises 1,4:3,6-dianhydrohexitol.

Preferably, (iv) (that is, a cycloaliphatic diol or an aromatic diol) comprises 2,2-diphenylpropanediol-1,3, cyclohexanedimethanol and/or tricyclododecanedimethanol.

Preferably, the amide-forming agent (v) is selected from 1,4-diaminobutane, 1,5-diaminopentane, 1,6-diaminehexane, 2,2,4-trimethylhexane-1,6-diamine, 2,4,4-trimethylhexane-1,6-diamine, 2-(2-aminoethoxy)ethylamine (diamino glycol), 1,3-diaminomethylcyclohexane, 1,4-diaminomethylcyclohexane, 1,3-diamino-2-methylcyclohexane, 1,3-diamino-4-methyl cyclohexane, 4-(2-aminopropane-2-yl)-1-methylcyclohexaneamine (1,8-diamino agent), 3-aminomethyl-3,5,5-trimethylcyclohexylamine (isophoronediamine or IPDA), bicycloheptanedimethylamine (bis(aminomethyl)norbonane), tricyclodecanedimethylamine (also referred to as TCD-DA), 4,4′-methylene(cyclohexylamine), 4,4′-di(aminocyclohexyl)methane or dicykan or PACM), 4,4′-diamino-3,3′-dimethylcyclohexylmethane (dimethylcykan), 1,3-bis-(aminomethyl)benzene, 1,4-bis(aminomethyl)benzene and 6-phenyl-1,3,5-triazine-2,4-diamine (benzoguanamine) or any mixtures thereof.

Preferably, the polyester starting mixture comprises
(i) from 45 to 55 mol % of an unsaturated dicarboxylic acid, an ester or an anhydride thereof;
(ii) from 4 to 39 mol % of an aliphatic diol;
(iii) from 2 to 31 mol % of dianhydrohexitol;
(iv) from 2 to 31 mol % of a cycloaliphatic diol or an aromatic diol; and
(v) from 1 to 22 mol % of an amide-forming agent.

Preferably, the polyester amide is obtained from a polyester starting mixture having at least one of these preferred features by polycondensation.

The water formed in the condensation reaction is preferably removed.

Curing of a high-temperature liner having one or several of these preferably designed features of the resin composition and/or having one or several of these preferably designed features of the polyester starting mixture allowed to obtain especially hydrolysis-resistant and thermally stable high-temperature liners.

### Internal Coating or Moisture-Repellent Tube

The internal coating or the moisture-repellant tube can preferably have a thickness in a range from 50 to 1000 μm, very particularly preferably from 100 to 700 μm. The internal coating or the moisture-repellant tube can preferably consist of one or several layers.

At least one of the layers can contain at least 20% by weight, preferably at least 90% by weight of a material selected from the group of silicone (or poly(organo)siloxane), polypropylene, polymethylpentene, polyethylene, crosslinked polyethylene, poly(organo)siloxanes, fluoropolymers, fluoroelastomers, nitrile rubbers, aliphatic polyketones, polyetherketones, polyphenylene sulfides and/or any mixtures thereof. This layer preferably has a thickness in a range from 10 to 250 μm. Hereinbelow, this layer will also be referred to as a protective layer. Preferably, one layer can consist of these materials. Mixtures thereof can be made from blends of the materials. For example, one layer can also contain at least more than 60% by weight of mixtures of these materials. For example, the internal coating can contain at least more than 60% by weight of these materials or any mixtures thereof.

The fluoropolymers in the preceding sections can preferably be selected from PVDF, ETFE, PFA, PTFE, PVF and/or mixtures and/or copolymers thereof.

Nitril rubber (NBR) can preferably be hydrogenated nitril rubber (H-NBR).

The aliphatic polyketones can preferably be Carilon, Poketone or mixtures and/or copolymers thereof.

The polyetherketone can preferably be selected from PEK, PEKK, PEEK, PEEKK, PEKEKK and/or mixtures and/or copolymers thereof.

Optionally, a use layer can be arranged on the internal coating or the moisture-repellant tube on the side facing the interior of the pipe (that is, the side facing away from the fibrous layer). This use layer serves to protect the other layers during installation and/or operation. This use layer can consist of a polymer, especially predominantly a polymer such as polypropylene, polyester, polyvinyl chloride, polyurethane, polycarbonate, polymethylpentene, polyethylene, crosslinked polyethylene, poly(organo)siloxanes, polyvinylidene fluoride (PVDF), fluoropolymers, fluoroelastomers, nitrile rubbers, aliphatic polyketones, polyetherketones, polyphenylene sulfides and/or mixtures thereof, particularly preferably consist thereof. This polymer can also be fabric-reinforced. It can be a fabric-reinforced PVC film, for example. The use layer can have a thickness in a range from 30 to 200 μm.

The internal coating or the moisture-repellant tube can preferably also comprise a styrene barrier layer. This layer can preferably have a thickness in a range from 5 to 100 μm, particularly preferably a thickness in a range from 10 to 40 μm. The styrene barrier layer can be or comprise a polyamide, EVOH or a polyamide copolymer film, for example. This film can have a thickness in a range from 5 to 60 μm, for instance. This layer can also be a component of a composite film made of PE/PA/PE, PP/PA/PP, P4M1P/PA/P4M1P (polymethylpentene, e.g., poly(4-methyl-1-pentene)), PE-X/PA/PE-X (PE-X=crosslinked polyethylene). In addition, an adhesion promotor can be disposed between the composite film layers.

Hence, the moisture-repellent tube can be a silicone tube, for example, that is inserted in the cured liner. Due to the high pressure within the high-temperature pipe such as a district heating pipe, for example, this tube then rests against the cured liner. Naturally, this principle preferably also applies to all other materials of the moisture-repellent tube.

However, the internal coating can also consist of a polyetherketone layer which has been laminated with a polypropylene nonwoven fabric serving as an anchor layer and which rests against the inside of the liner with the anchor layer before the liner cures on the resin-impregnated fibrous layer. Once the resin is cured, a certain amount of resin will also have penetrated the anchor layer and hence integrally bond the internal polyetherketone coating to the fibrous layer after curing. Naturally, this principle also applies to all other above-mentioned materials and combinations of materials of the anchor layer and/or the internal coating. For example, the internal coating or the moisture-repellant tube has an area where the internal coating or the moisture-repellant tube overlaps with itself. This overlapping area can be in a range from 5 to 20 mm. Contrary to a butt joint, this allows particularly well to ensure that water vapour from the high-temperature pipe does not reach the cured resin in the overlapping area, for example. This can also be achieved by using a tape on the joint (butt joint or overlapping area).

The internal coating or the moisture-repellant tube is preferably configured to be impermeable to vapour, thus preventing water vapour from the high-temperature pipe from reaching the cured resin.

The internal coating or the moisture-repellant tube is preferably permeable to UV radiation. This has the advantage that the resin composition can be cured by UV light.

The styrene barrier layer can be combined with the protective layer also within composite films. Hence, this composite film can preferably consist of a polyamide or EVOH sandwiched between two layers of materials selected from polypropylene, polymethylpentene, polyethylene, crosslinked polyethylene, poly(organo)siloxanes, fluoropolymers, fluoroelastomers, nitrile rubbers, aliphatic polyketones, polyetherketones, polyphenylene sulfides and/or mixtures and/or combinations thereof. Such a composite film can preferably have a thickness in a range from 50 to 200 μm. The internal coating or the moisture-repellant tube can preferably consist of such a composite film. In addition, an adhesion promotor can be disposed between the composite film layers.

For example, composite films such as (NBR or H-NBR)/PA/(NBR or H-NBR) or Carilon/PA/Carilon can be used.

The internal coating can also comprise a metal foil. This foil can have a thickness in a range from 10 to 100 μm, for instance.

The internal coating or the moisture-repellant tube can preferably comprise a polymer layer on the side facing the fibrous layer and/or the anchor layer. This polymer is preferably selected from polypropylene, polyester, polyvinyl chloride, polyurethane, polycarbonate, polymethylpentene, polyethylene, crosslinked polyethylene, poly(organo)siloxanes, fluoropolymers, fluoroelastomers, nitrile rubbers, aliphatic polyketones, polyetherketones, polyphenylene sulfides and/or mixtures thereof. If an internal coating is used, the polymer of this layer is particularly preferably identical with the polymer of the anchor layer. This layer can preferably have a thickness in a range from 20 to 150 μm. This layer allows the anchor layer to bond to the internal coating in a particularly reliable manner, for example.

### Fibrous Layer

The fibres of the fibrous layer are preferably glass fibres.

The at least one fibrous layer can preferably have a thickness in a range from 2 to 30 mm.

The fibre tube layer is preferably a non-crimp fabric, a fabric, a mat, a weft knit fabric, a nonwoven fabric, a felt, knitted fabric or a combination or a multi-layer structure of these textile fabrics. The material of the fibres of the resin-impregnated fibre tube layer is preferably selected from glass, carbon, aramid, gel-spun polyethylene (Dyneema®, for example), PAN, a thermoplastic polymer or mixtures thereof. Thermoplastic fibres can be made of polypropylene, polyethylene or polyester, for example. The resin material can preferably be configured as described above in greater detail.

The fibrous material of the at least one fibrous layer preferably contains at least 90% by weight of glass fibres relative to the weight of the fibrous material. Alternatively, it may also be preferred that the fibrous layer contains at least 60% by weight of thermoplastic polymer fibres and less than 40% by weight of glass fibres relative to the weight of the fibrous material.

Preferably the at least one fibrous layer consists of a fibrous layer that is connected at the longitudinal edges and thus forms a tube. Therefore, the at least one fibrous layer preferably comprises a longitudinal seam. This longitudinal seam is preferably a seam sewn with threads (polyester yarn or twine), for example. Therefore, the fibrous layer or fibrous sheet does not overlap with itself, for instance. This allows to prevent the fibrous layer or fibrous sheet from overlapping with itself. This ensures a significantly higher conformity of the fibrous layer thickness.

The high-temperature liner according to an embodiment of the invention can preferably also contain from 2 to 20, particularly preferably from 3 to 12 fibrous layers. When impregnated, these layers are preferably movable relative to each other and not solidly bonded or even sewn to each other. This has the advantage that they can optimally adapt to defects in the high-temperature pipe to be rehabilitated such as a district heating pipe, for example, when installed.

### Anchor Layer

An anchor layer can be arranged between the internal coating and the fibrous layer. The preferably provided anchor layer that preferably consists of a polymer material has again preferably a thickness in a range from 10 to 5000 μm, especially from 30 to 500 μm. Alternatively preferably, the thickness can also be in a range from 800 to 3000 μm. The anchor layer contains preferably one, in particular preferably consists of a nonwoven fabric or a melt adhesive or a combination of these variants. Exceptionally preferably, the nonwoven fabric consists of glass, thermoplastic materials, PAN, carbon fibres or mixtures thereof. The thermoplastic materials are selected from polyethylene, polypropylene or polyester, for instance. The melt adhesive is a polyamide, polyethylene, APAO (amorphous polyolefin), EVAC (ethylene-vinyl acetate copolymer), TPE-E (polyester elastomer), TPE-U (polyurethane elastomer), TPE-A (copolyamide elastomer) or a vinylpyrrolidone/vinyl acetate copolymer and mixtures thereof, for example.

### Exterior Layer

The exterior layer preferably has a thickness in a range from 40 to 2000 μm. Preferably, the exterior layer is impermeable to UV radiation to prevent the resin in the resin-impregnated fibre tube layer from curing during storage or transport, for example. The exterior layer can consist of a polymer or also of a nonwoven fabric laminated with a polymer, for example. PVC, polyethylene or polypropylene, for example, are suitable as a material for the polymer or the nonwoven fabric. This layer can also be fibre-reinforced.

The exterior layer can consist of several layers. The exterior layer can preferably also have a styrene barrier layer. Said styrene barrier layer can have the preferred properties described above. This styrene barrier layer or an adjacent layer can also bond to (be laminated on, for example) a nonwoven fabric. The exterior layer can also contain a fibre-reinforced polymer layer (fabric-reinforced PVC, for example).

### FURTHER EMBODIMENTS

In another embodiment, an advantageous feature of the invention is achieved by a rehabilitated high-temperature pipe (such as a district heating pipe, for example), characterised in that a cured high-temperature liner is disposed within the high-temperature pipe.

In another embodiment, an advantageous feature of the invention is achieved by the use of a high-temperature liner for the rehabilitation of high-temperature pipes (such as district heating pipes, for instance).

In another embodiment, an advantageous feature of the invention is achieved by a process for rehabilitating high-temperature pipes, characterised in that a high-temperature liner is inserted into a high-temperature pipe (such as a district heating pipe, for example) and cured therein. For example, this process can be carried out according to any one of the above-mentioned variants A to D.

### Exemplary Embodiment

Condensation of an unsaturated polyester resin:

The unsaturated polyester resin was prepared by weighing in 812.67 g of neopentyl glycol, 759.87 g of isosorbide, 442.91 g of isophoronediamine, 38.34 g of maleic anhydride, 116.36 g of phthalic anhydride, 224.80 g of trimellitic anhydride, 2 g of hydroquinone, 1.8 g of hydrogenated monobutyltin oxide, 1969.46 g of fumaric acid and 618.90 g of cyclohexanedimethanol into a 6 l 4-necked flask of a condensation apparatus and heating the mixture to 140° C. with continuous stirring and under a continuous nitrogen purge (20 l/h) within 2 h and maintaining it at 140° C. for 55 min with water beginning to separate. Subsequently, the reaction temperature was increased to 170° C. with a heating rate of about 10 K/h, observing 1 h intervals every 10 K in which the temperature was kept constant, and subsequently cooled to room temperature. Next day, the reaction charge was uniformly heated to 170° C. within about 210 min. Subsequently, the temperature was increased to 200° C. at 12 K/h and kept at 200° C. for 4 h for postcondensation while the water separation continued. Then the polyester was cooled to room temperature by switching off the heating. The obtained polyester amide was solid.

The acid value determined by titration was 20 mg KOH/g of the UP.

### Preparation of the Resin Composition:

In the preparation of the resin, 56 g of the thus prepared unsaturated polyester resin and 44 g of styrene were added to a one-neck amber glass flask and stirred until the unsaturated polyester was completely dissolved. This could take several days. Thereafter, 2.1 g of Covestro DESMODUR XP2675 (hexamethylene diisocyanate, HDI trimers), 0.25 g of diphenyl(2,4,6-trimethylbenzoyl)phosphine oxide, 0.075 g of 2-methyl-4′-(methylthio)-2-morpholinopropiophenone, 1.2 g of 1,1-bis(tert.-butylperoxy)-3,3,5-trimethylcyclohexane were added and mixed up. This composition was stored in amber glass bottles.

This process was repeated until sufficient resin composition for the following experiments had been obtained. The hardeners and/or thickeners were added at the very end.

### Liner Prototypes:

A liner prototype for high-temperature applications was developed by using a dry liner material of the Saertex multiCom company (type: DN/WD 200/4, part number 10189045). This dry material consisted of two non-crimp glass fabrics (inner liner and outer liner) which were not connected with each other and formed a tube. The non-crimp fabrics were arranged one above the other such that the respective main warps were parallel to the tube axis. Inside the dry liner material was an internal coating with a styrene barrier layer forming the inner surface of the liner. During installation, said layer is inflated with compressed air within the pipe, as a result of which the liner is pressed against the wall of the old pipe or into a support cap.

Circular specimens having a diameter of approximately 10 cm were cut out of the dry material (type: DN/WD 200/4), placed in a watch glass with the nonwoven fabric side facing down and impregnated with the resin composition. This was achieved by pouring the resins on the side of the non-crimp fabrics of the liner (that is, from above) and removing air bubbles in the resin with a wooden spatula. The impregnation was completed when the bottom side of the nonwoven fabric was completely impregnated with resin.

Subsequently, the liner specimens impregnated with the resin composition were cured with UV light.

In order to determine the glass transition temperatures, the cured liner specimens were trimmed to 50 mm×10 mm using a circular saw and ground down to a thickness of 2 mm with a hand-held grinder.

In order to determine the hydrolytic stability and the thermal stability, the specimens were stored in water at 200° C. and at a pressure of 5 bars for one week. No hydrolytic effects were observed. Depending on the specimen and the batch, glass transition temperatures from approximately 210° C. to 240° C. were determined. It was observed that the glass transition temperature even increased after the storage in water, which supports a post-curing. The specimens did not show any abnormality with respect to flexibility, local hardening, discolourations or gas evolution. Indications of hydrolytic damage of the network were not apparent.

Subsequently, the glass transition temperature was determined by performing a dynamic-mechanical analysis (DMA).

Parameters and measurement settings of the performed DMA analyses:
Sample dimensions: 50×10×5 mm
Deformation mode: Dual cantilever bending
Amplitude: 30 μm
Dynamic force: 7.55 N
Static force: 4 N
Temperature range: 20-160° C.
Heating rate: 2 K/min
Frequency: 1 Hz/10 Hz
Atmosphere: N₂
N₂ flow rate: 5 ml/min

Each DMA measurement was performed after storing the specimen in an autoclave in water at 200° C. for a certain time. The glass transition temperature of the specimens after the respective storage time is listed in the following table.

The post-curing of the thermoset plastic at 200° C. during the first 168 h could be seen. Further, it could be seen that the glass transition temperature remained constant between 312 h and 1032 h; that is, neither a thermal nor a hydrolytic network degradation occurred.

A dry material 0.47 m wide by 12 m long consisting of a 2 mm inner liner and a 2 mm outer liner (commercially available Saertex S-Liner) was used to produce the impregnated fibre tube (liner) according to an embodiment of the invention. Inside the dry material was an internal coating 500 μm thick that consisted of a PP/PA and PP nonwoven fabric combination. Subsequently, this dry material was impregnated with 35 kg of the above prepared resin composition under vacuum.

This liner was inserted in a test pipe with an internal diameter of 300 mm using standard techniques and cured with UV light.

The features of the invention disclosed in the present description, in the drawings as well as in the claims both individually and in any combination may be essential to the realisation of the various embodiments of the invention. The invention is not limited to the described embodiments. It may be varied to the extent as falls into the scope of the invention, taking into account the knowledge of one skilled in the art.

What is claimed is:

1. A multilayered high-temperature liner comprising:
a fibrous layer contains fibres that have been impregnated with a resin composition prior to curing, and
an internal coating or a moisture-repellent tube that forms the final layer within the rehabilitated high-temperature pipe containing the cured high-temperature liner in the direction of the central axis of the high-temperature pipe has a thickness in a range of from 40 to 2000 μm.

2. The high-temperature liner according to claim 1, wherein the resin composition contains a reactive diluent and an unsaturated polyester obtained from a polyester starting mixture.

3. The high-temperature liner according to claim 2, wherein the unsaturated polyester is an unsaturated polyester amide.

4. The high-temperature liner according to claim 1, wherein the internal coating has a thickness in a range from 100 to 700 μm.

5. The high-temperature liner according to claim 1, wherein in that the high-temperature liner has a longitudinal seam in the longitudinal direction of the liner and said longitudinal seam is especially preferably provided in the internal coating and/or a fibrous layer.

6. The high-temperature liner according to claim 1, wherein the internal coating or the moisture-repellent tube consists of one or several layers and preferably at least one of these layers contains at least 20% by weight of a material selected from the group of polypropylene, polymethylpentene, polyethylene, crosslinked polyethylene, poly(organo)siloxanes, fluoropolymers, fluoroelastomers, nitrile rubbers, aliphatic polyketones, polyetherketones, polyphenylene sulfides and/or any mixtures thereof.

7. The high-temperature liner according to claim 1, wherein an anchor layer is arranged between the internal coating and the fibrous layer, wherein the thickness of the anchor layer is in a range of from 10 to 5000 μm, wherein the anchor layer contains a nonwoven fabric made of glass, thermoplastic materials, PAN, metal, carbon fibres or mixtures thereof.

8. A rehabilitated high-temperature pipe, wherein a cured high-temperature liner according to claim 1 is arranged in the high-temperature pipe.

9. A process for rehabilitating high-temperature pipes, wherein a high-temperature liner according to claim 1 is inserted into a high-temperature pipe and cured therein.
